(19) United States
(12) Patent Application Publication
(10) Pub. No.: US 2002/0147690 A1
(43) Pub. Date: Oct. 10, 2002

(54) E-commerce using an identifier

(76) Inventors: Richard K. Tam, Monte Sereno, CA (US); Mark A. Resmer, Campbell, CA (US)

Correspondence Address: SKJERVEN MORRILL LLP, 25 METRO DRIVE, SUITE 700, SAN JOSE, CA, 95110, US

(21) Appl. No.: 09/827,360

(22) Filed: Apr. 4, 2001

(51) Int. Cl. G06F 17/60

(52) U.S. Cl. 705/64

(57) ABSTRACT

In accordance with the invention, a signal encoded with a plurality of characters (“transaction identifier”) identifies a transaction between a buyer and a seller. The transaction identifier includes a first string of characters that identifies the buyer and a second string of characters that identifies a product. In one embodiment, the transaction identifier further includes a third string that identifies at least one of the following: the seller; the delivery method; the issuer of the transaction identifier; the expiration date of the transaction identifier; the creation date of the transaction identifier; and the maximum number of times the transaction identifier can be used. In another embodiment, the transaction identifier is created before the buyer is aware of the transaction.

### CROSS-REFERENCE TO RELATED APPLICATIONS

This application is related to and incorporates by reference herein the commonly owned co-pending U.S. patent application Ser. No. ______, entitled “DATA STRUCTURE FOR HOLDING PRODUCT INFORMATION,” inventors Tam et al., filed ______, attorney docket number M-9128 US, U.S. patent application Ser. No. ______, entitled “E-COMMERCE USING A DATABASE,” inventors Tam et al., filed ______, attorney docket number M-8689 US, and U.S. patent application Ser. No. 09/536,192, entitled “REPOSITORY FOR PUBLISHING CONTENT IN DIFFERENT FORMS,” inventors Tam et al., filed Mar. 17, 2000.

### BACKGROUND

U.S. Pat. No. 5,960,411 (incorporated by reference herein in its entirety) describes a system and method in which a “client system is provided with an identifier that identifies a customer. The client system displays information that identifies the item and displays an indication of an action (e.g., a single action such as clicking a mouse button) that a purchaser is to perform to order the identified item. In response to the indicated action being performed, the client system sends to a server system the provided identifier and a request to order the identified item. The server system uses the identifier to identify additional information need to generate an order for the item and then generate the order” (see column 2, lines 51-62).

Programming a VCR to record a television program can be difficult for some users. Thus, VCR manufacturers have included a feature called “VCR Plus+” in some VCRs. VCR Plus+ allows a user to program the VCR to record a television program by entering a “PlusCode” found beside program titles in TV listings.

### SUMMARY

In accordance with one aspect of the invention, a single code (“transaction identifier”) identifies a unique transaction that can happen between a buyer and a seller. The transaction identifier is more than just “an identifier that identifies a customer,” as described in the above-referenced U.S. Pat. No. 5,960,411. Instead, the transaction identifier identifies a specific buyer (from among a number of such buyers) and also identifies a specific product (from among a number of such products). Note that the word “product” as used herein is also intended to cover services (such as dry cleaning). The two identities of the specific buyer and the specific product can be combined in any manner to form a transaction identifier of the type described herein, as long as these two identities can be recovered therefrom. The transaction identifier can be embedded in advertisement generated by any source as long as the two identities can be recovered from the transaction identifier to consummate the transaction.

### BRIEF DESCRIPTION OF THE DRAWINGS

FIGS. 1A and 1B illustrate, in block diagrams, the purchase of an item by a buyer from a seller using a transaction identifier in accordance with one aspect of the invention.

FIG. 1C illustrates a paper catalog containing an advertisement of FIG. 1A.

FIGS. 1D and 1E illustrate methods by which a buyer sends a transaction identifier to a seller.

FIG. 2 illustrates, in a flowchart, a method to purchase an item using the transaction identifier in accordance with one embodiment of the invention.

FIG. 3 illustrates a web page form used to register the buyer with the seller of FIG. 1A.

FIG. 4 illustrates an electronic mail notification of the password of FIG. 1A.

FIGS. 5A through 5D illustrate strings of the transaction identifier of FIG. 1A.

FIGS. 6A through 6J illustrate tables in a database of FIG. 1B.

FIGS. 7A through 7E illustrate advertisements sent to the buyer by the seller of FIG. 1A.

FIGS. 8A and 8B illustrate, in block diagrams, the purchase of an item by a buyer from a seller through a transaction identifier provider in accordance with another aspect of the invention.

FIG. 9 illustrates, in a flowchart, a method to purchase an item via the transaction identifier provider of FIG. 8A in accordance with one embodiment of the invention.

FIG. 10 illustrates a web page form used to register the seller with the transaction identifier provider of FIG. 8A.

FIGS. 11 and 14 illustrate tables in a database of FIG. 8B.

FIGS. 12 and 13 illustrate strings of the transaction identifier of FIG. 8A.

### DETAILED DESCRIPTION

In one embodiment, a database is used, and a record in the database relates a transaction identifier to the identities of a buyer and a product being encoded. Therefore, in this embodiment the two identities cannot be recovered from the transaction identifier in the absence of the database. In an alternative embodiment, the transaction identifier includes a first string (also called “buyer code”) of characters that identifies the buyer, and a second string (also called “product code”) of characters that identifies a product to be purchased by the buyer. In this embodiment, the two strings may be located at fixed positions relative to one another in the transaction identifier (e.g., the product code may be appended to the buyer code or vice versa). Alternatively the two strings can be interleaved among each other so that within such a transaction identifier a character of one string alternates with a character of the other string. Also, a character used in the transaction identifier can be any character on a keyboard, such as a character from ASCII, EBCDIC or even kanji (in case of Japanese, Korean or Chinese language keyboard).

In one implementation, the transaction identifier further identifies a fulfillment method for physical transfer of the product (or service) to the buyer. In one variation, the fulfillment method includes one of: delivery of the product to the buyer, and pickup of the product by the buyer at a predetermined location. So, depending on the embodiment, the transaction identifier can include a third string (also called “fulfillment code”) of characters. In another implementation, instead of or in addition to the just-described third string (depending on the variant), the transaction identifier further includes a character string (also called “expiration date”) that identifies a date when the transaction identifier expires. In various examples, multiple such strings can be concatenated to one another, or may be all interleaved among each other. Alternatively, one or more of such strings may be recovered from a database.

In accordance with another aspect of the invention, an online shopping method includes: sending a transaction identifier to a buyer, and receiving the same transaction identifier back from the buyer if the buyer wishes to purchase a product. In one embodiment, sending the transaction identifier includes generating and sending an advertisement or an offer to sell with or containing the transaction identifier to the buyer, and the buyer returns the transaction identifier to make a purchase. In another embodiment, a transaction identifier is not sent with or in the advertisement. Instead, the advertisement only contains a product code and a fulfillment code. The buyer assembles the transaction identifier by combining (e.g. appending) a buyer code (known to the buyer) to the code(s) in the advertisement, and transmits such a transaction identifier to the seller. In another embodiment, a number of transaction identifiers are provided to the buyer, and the buyer transmits one or more selected transaction identifiers to buy the item(s).

An advertisement that contains one or more of the above-described code(s) can be provided to the buyer in any manner, e.g. physically delivered in tangible form, such as via pamphlet, catalog, flyer or even delivered in an intangible form, such as via web page or even email. Regardless of the form, in one embodiment each advertisement that is provided to a specific buyer is customized by use of that buyer code in the transaction identifier that is normally included in the advertisement. In one implementation, the method further includes relating the transaction identifier to at least one of the product and the buyer e.g., to identify additional information about the product and/or about the buyer. In one variation, the method further includes delivering the product to an address of the buyer.

In another embodiment, the method further includes the buyer receiving additional information (also called “product information”) about a product from a seller. Product information includes a product number, one or more available fulfillment methods, price(s) based on fulfillment, and a description (which can be one or more of text, drawings, audio, and video) of the product. In one implementation, sending the transaction identifier includes sending to the buyer (e.g. via an “aggregator”) an advertisement generated from the product information, and the advertisement includes the transaction identifier. Depending on the variant, the transaction identifier is distinctly identified as such, thereby to allow the buyer to, e.g., enter the transaction identifier on a keypad of a phone or a keyboard of a computer. In one variation, the method further includes (1) relating the transaction identifier received back from the buyer to at least the product, (2) the buyer sending the product code, an address of the buyer, and optionally the fulfillment method to the seller (or to a clearinghouse), and (3) the seller (or a fulfiller acting on behalf of the seller) delivering the product to the buyer.

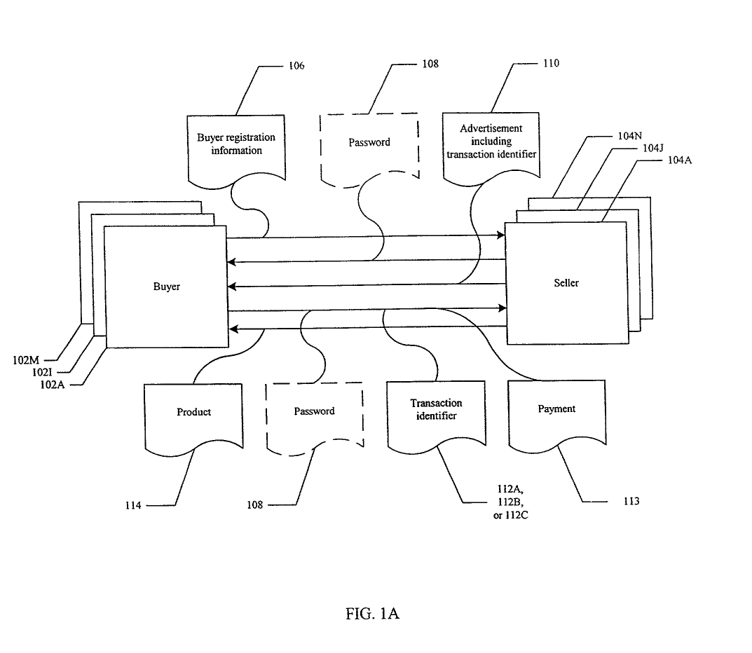

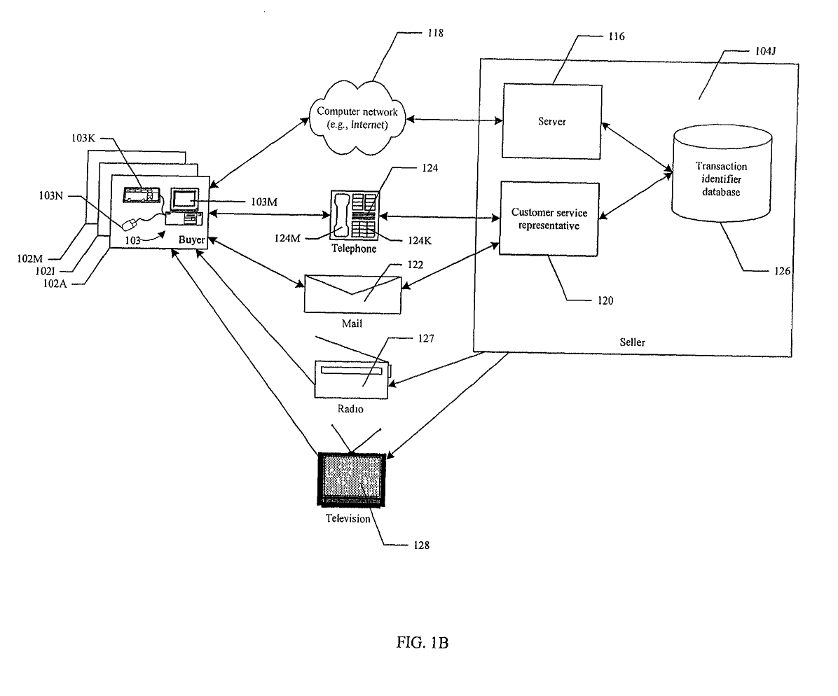

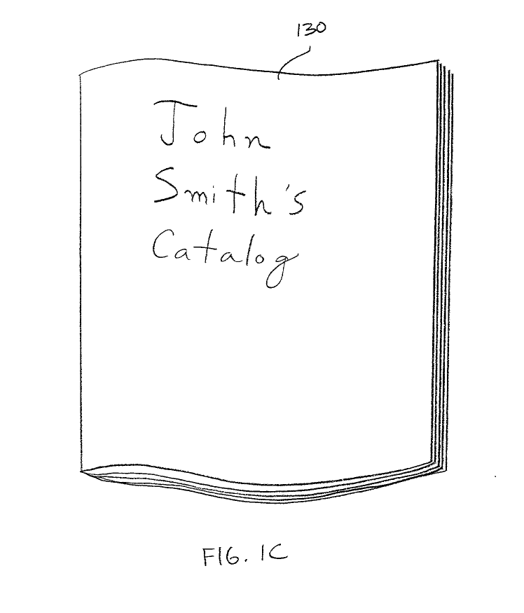

In one embodiment of the invention, a buyer 102I (FIG. 1A) purchases a product by sending to a seller 104J only a string of characters hereinafter called “transaction identifier” that uniquely identifies a transaction from among a number of possible transactions. A string of characters of one embodiment is a contiguous set of alphanumeric characters A-Z and 0-9. In one implementation, a string of characters does not contain numbers (e.g., 0-9) used for calculations. In other embodiments, punctuation characters such as a space, a hyphen, or a period may be included in the contiguous set that forms the transaction identifier. When included, each punctuation character is preceded and followed by alphanumeric characters. For example, the transaction identifier, when used in a predetermined manner, identifies at least the buyer and the product being purchased. Note that the transaction identifier can also be a barcode or a bit pattern instead of a string of characters. However, a string of characters allows buyer 102I to easily read and provide the transaction identifier to another such as seller 104J.

Unlike some prior art methods (e.g. traditional mail, telephone, or online orders), buyer 102I does not send to seller 104J, at the point of each purchase, any buyer information such as his or her name, address, and billing information. In this embodiment, buyer 102I also does not send product information such as product name or number, quantity being ordered, and price. Also in this embodiment, buyer 102I does not send the date of delivery and the delivery method. Instead, such information and various legal terms and conditions that are applicable to each transaction with the buyer are provided to and approved by the buyer ahead of time, e.g. during registration. Similarly, the buyer is required to provide, ahead of time, the buyer information. Note that in other embodiments, a buyer may provide some of the above-described information at the point of purchase although in each embodiment, the transaction identifier identifies at least two of the following: (1) buyer information, (2) product information, (3) seller information, (4) delivery information, (5) an issuer of the transaction identifier, (6) an expiration date to complete the transaction, (7) a creation date of the transaction identifier, and (8) a maximum number of times the transaction identifier can be used. In one specific embodiment, the transaction identifier does not itself contain the various terms and conditions because it is just a code.

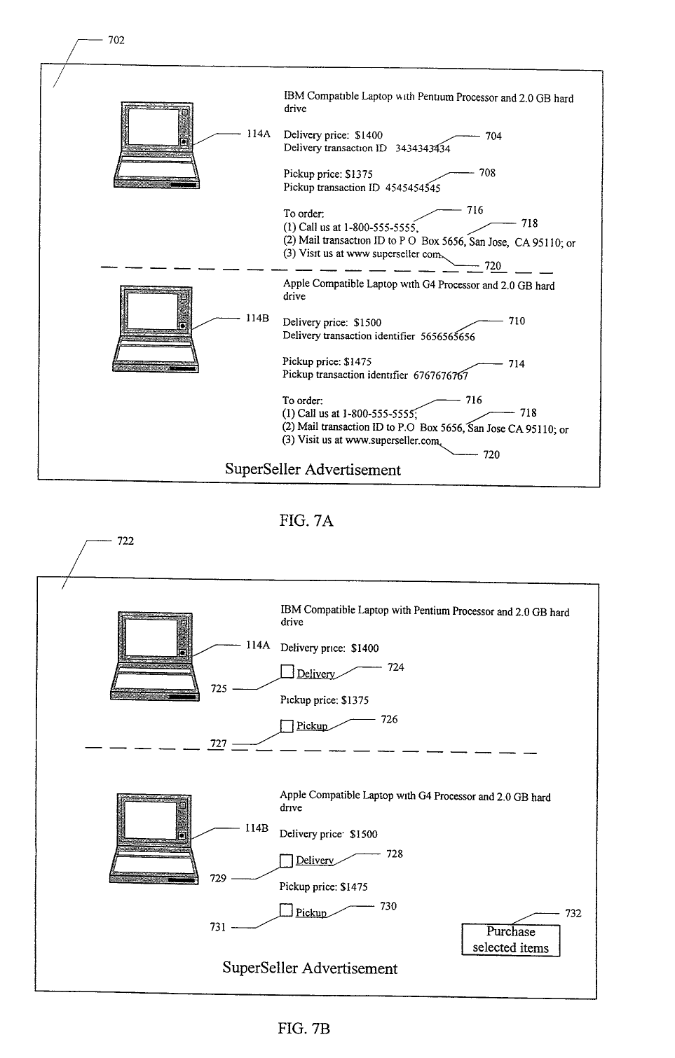

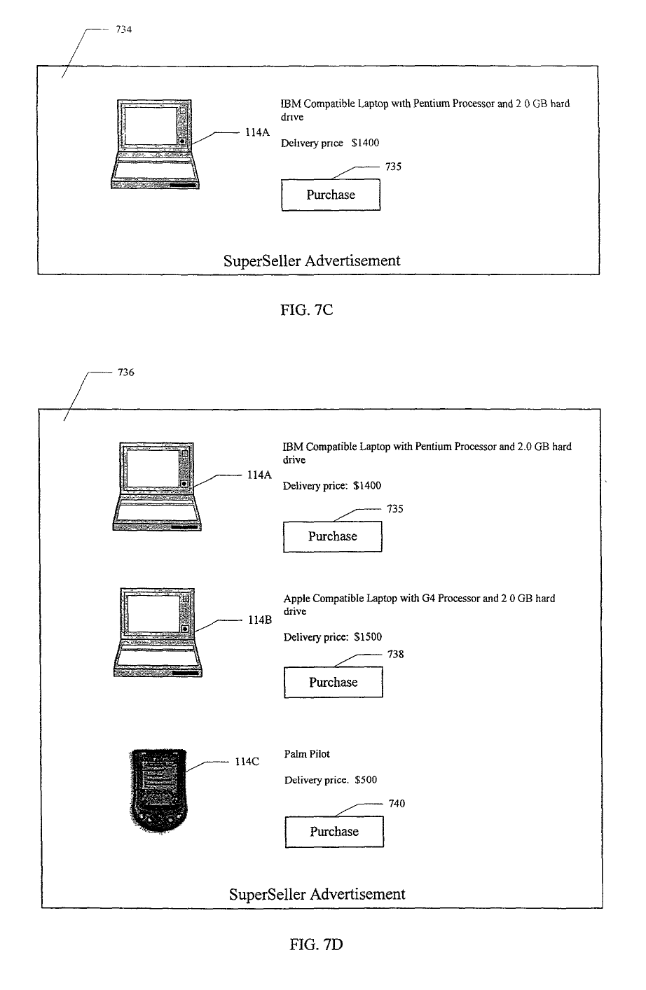

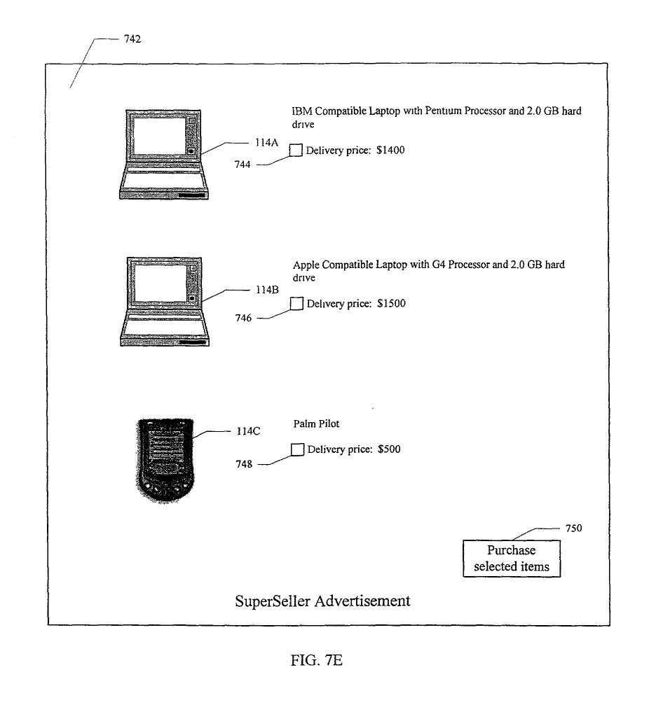

Once a buyer is registered, the buyer receives product information that is included in an advertisement (e.g., a paper catalog 130 in FIG. 1C or web pages in FIGS. 7B through 7E) that also includes the transaction identifier. The transaction identifier is related to the aforementioned product and buyer information, e.g. by a database, so that seller 104J can consummate the purchase without buyer 102I providing the aforementioned information for each transaction. Thus, this method provides a more efficient and pleasing shopping experience for buyer 102I.

A buyer 102I (wherein A<I<N, N being the total number of registered buyers) can use any method to provide the transaction identifier to seller 104J. As illustrated in FIG. 1B, buyer 102I may type in the transaction identifier via a keyboard 103K of a computer 103 (such as a PC running web browser software) connected via a network 118 to server 116 of seller 104J. Alternatively, a buyer 102I may simply click on a hyperlink or a button in a web page displayed on a monitor 103M. In one variant, the transaction identifier is explicitly displayed, as illustrated in FIG. 7A, while in another variant such a transaction identifier is hidden although in fact transmitted when the hyperlink or button is clicked, as illustrated in FIGS. 7B through 7E (e.g. via mouse 103N in FIG. 1B). A buyer 102I may also send the transaction identifier to seller 104J by simply reading it aloud into a microphone 124M of a telephone 124, or by punching it on a keypad 124K of telephone 124 (see FIGS. 1B and 1D). Alternatively, buyer 102I can send the transaction identifier by mail (e.g. by sending a letter or post card 132 of FIG. 1E having thereon a sticker 134 that bears the transaction identifier in mail 122).

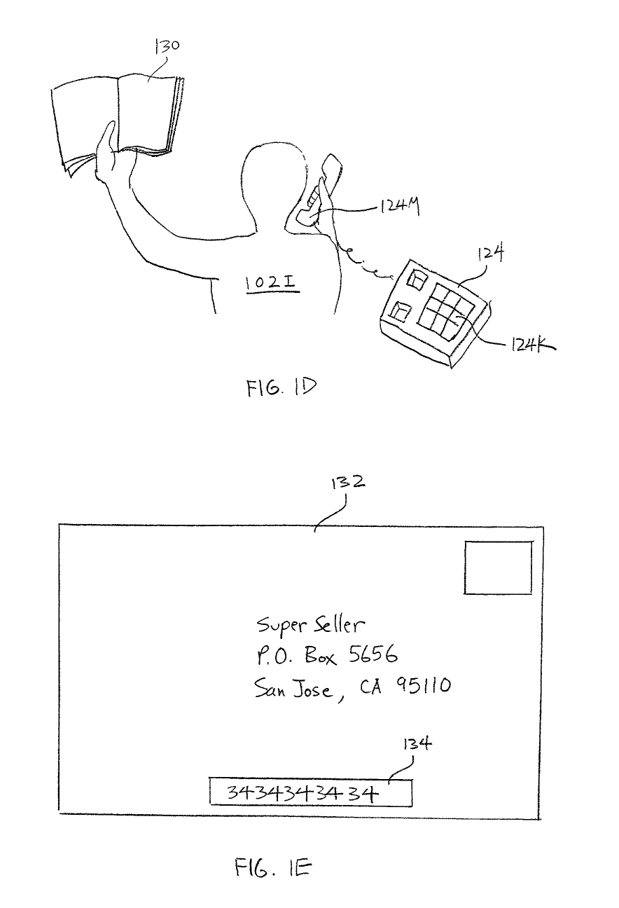

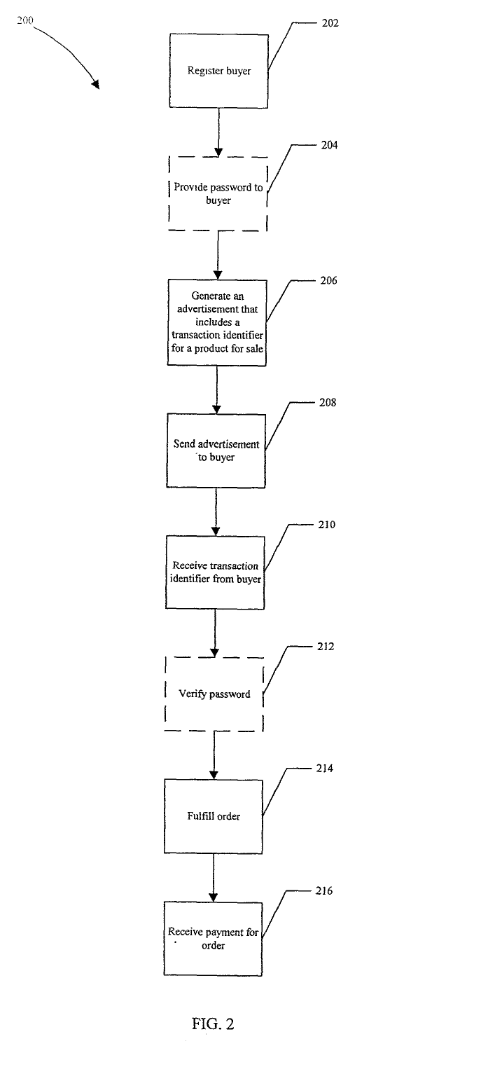

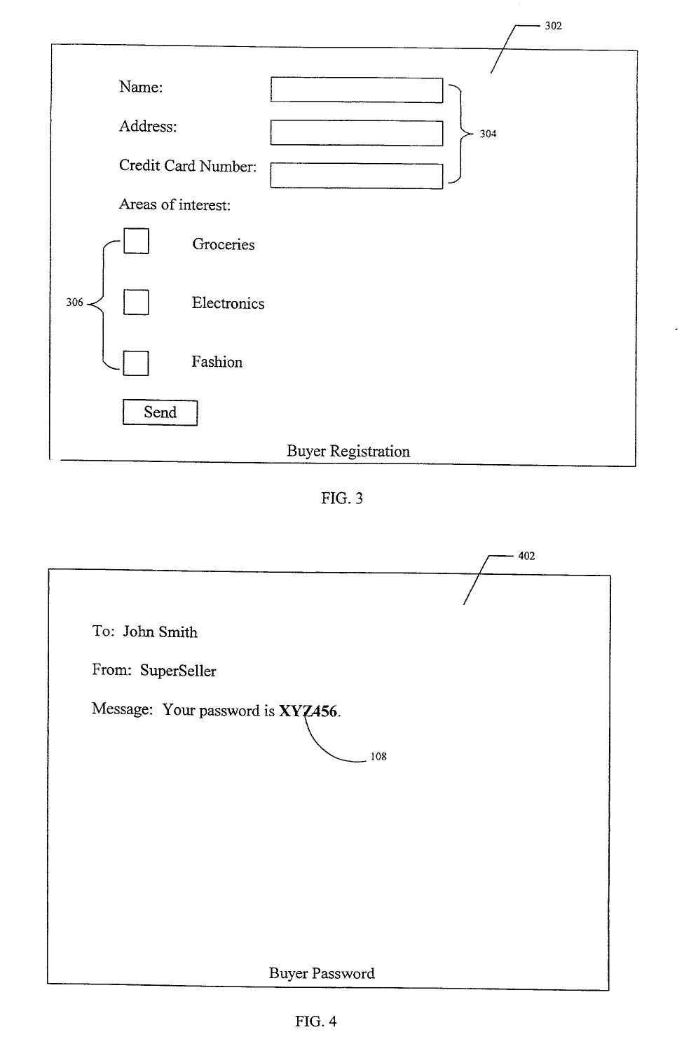

In action 202 (FIG. 2), a buyer 102I registers with seller 104J. In one embodiment, a buyer 102I registers (see action 202 in FIG. 2) with seller 104J by sending his or her name, address, credit card information, email address, and phone number (collectively shown as “buyer registration information 106” in FIG. 1A) to seller 104J. In one implementation, buyer 102I registers with seller 104J via a web page 302 (FIG. 3) generated by a server 116 (FIG. 1B) of seller 104J. Buyer 102I uses a browser to accesses web page 302 via a computer network 118 such as the Internet. Buyer 102I fills out text boxes 304 (FIG. 3) to send registration information 106 to seller 104J. Buyer 102I can also choose areas of interest in the products available from seller 104J (e.g., groceries, electronics, and fashion) by selecting one or more check boxes 306. In one variation, server 116 saves a file (e.g., cookie) that identifies buyer 102I in the computer 103 that buyer 102I is using to access server 116. Server 116 stores buyer registration information 106 in a transaction identifier database 126 (FIG. 1B).

In another implementation, buyer 102I sends registration information 106 to a customer service representative 120 (FIG. 1B) of seller 104J by a paper form sent via mail 122 or by voice or touch-tone over telephone 124. Customer service representative 120 stores registration information 106 in transaction identifier database 126.

In action 204 (FIG. 2), seller 104J optionally sends buyer 102I a password 108 (FIG. 1A) to authenticate buyer 102I in subsequent transactions. In one implementation, server 116 sends password 108 to buyer 102I via a web page or an email 402 (FIG. 4). In another implementation, customer service representative 120 sends password 108 to buyer 102I through mail 122 or over telephone 124. Note that instead of the seller sending the password to buyer, the buyer can select a password and send it to the seller as part of buyer registration information 106. Server 116 or customer service representative 120 stores password 108 along with registration information 106 in database 126.

In action 206 (FIG. 2), seller 104J generates an advertisement 110 (FIG. 1A) that includes one or more transaction identifiers for a product 114 offered for sale. Each transaction identifier identifies a sales transaction of a product between buyer 102I and seller 104J, from among a number of possible transactions. The transaction identifiers are created before buyer 102I is aware of the transactions. In one example, the transaction identifiers are created before buyer 102I receives advertisement 110 about product 114. In another example, the transaction identifiers are created before buyer 102I requests advertisement 110 (e.g., a web page advertisement) about product 114.

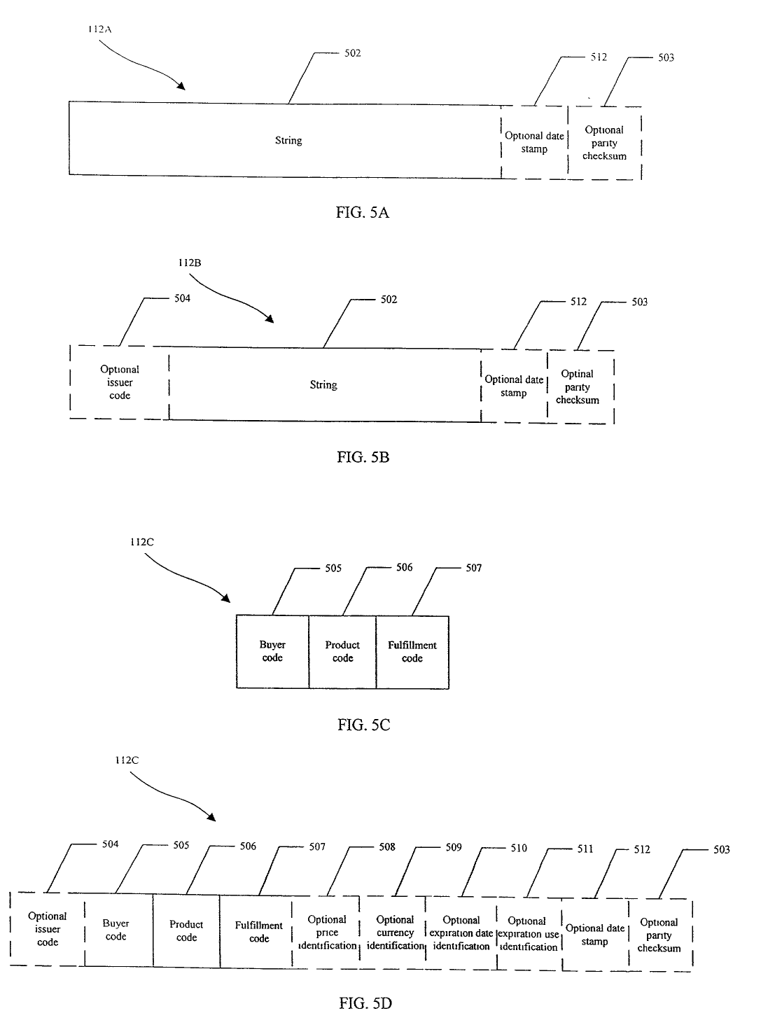

Depending on the implementation, server 116 can generate any of transaction identifiers 112A (FIG. 5A), 112B (FIG. 5B), or 112C (FIGS. 5C and 5D). Of note, server 116 generates transaction identifiers well before any advertisement (of product information) is displayed to a buyer, unlike U.S. Pat. No. 5,960,411 wherein a server system “completes the order by adding the purchaser-specific order information for the purchaser that is mapped to that client identifier to the item order information (e.g., product identifier and quality)” (see col. 3, lines 60-64). One advantage of generating a single code (that simultaneously identifies both the buyer and the product) prior to the advertisement display is that the code can be received by a computer that did not generate and transmit the advertisement. Such a computer would only need to be programmed (as appropriate) with instructions to decode the transaction identifier, and would need access to product and buyer information.

Transaction identifier 112A (FIG. 5A) includes a string 502 that uniquely identifies a transaction, an optional date stamp code 512 that identifies the date transaction identifier 112A is created, and an optional string 503 that identifies the parity checksum. The combination of string 502 and date stamp code 512 allows the same string 502 to be included in unique transaction identifiers that identify a later but identical transaction. One skilled in the art understands that other error checking and/or correction means may be used instead of the parity checksum. For instance, dual entry or encryption of transaction identifier 112A can also be used for error checking and/or correction. In one implementation, string 502 includes ten (10) alphanumeric characters (e.g., A-Z (capital letters) and 0-9), date stamp code 512 includes three (3) alphanumeric characters, and checksum 503 includes one alphanumeric character. Accordingly, transaction identifier 112A of this implementation includes at least fourteen (14) alphanumeric characters.

In one example, server 116 generates parity checksum 503 by taking the last digit of the arithmetic sum of the ASCII (American Standard Code for Information Interchange) codes of each alphanumeric character of string 502, and adding to this last digit, the value 41 (so that last digits of values 0-9 are mapped to characters A-J). Server 116 uses parity checksum 503 to check errors in string 502 received from buyer 102I over network 118.

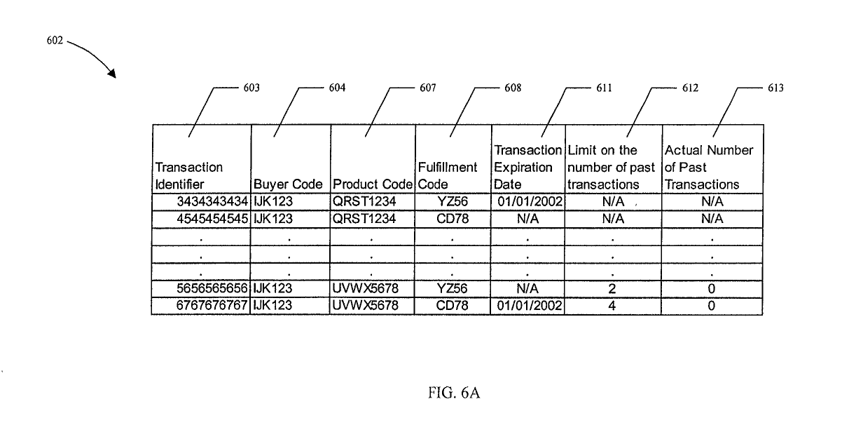

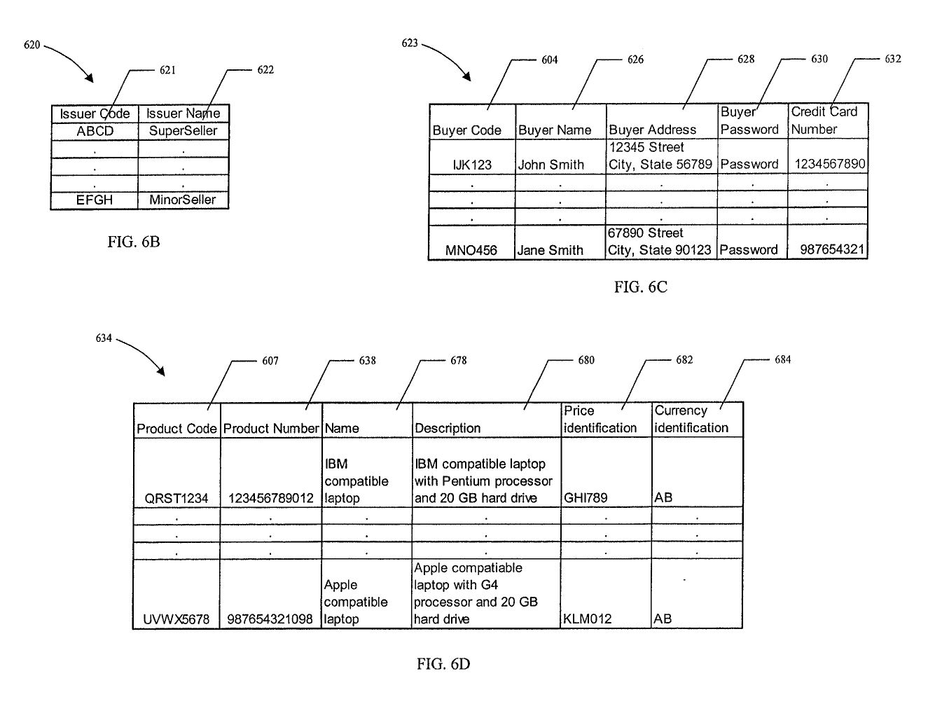

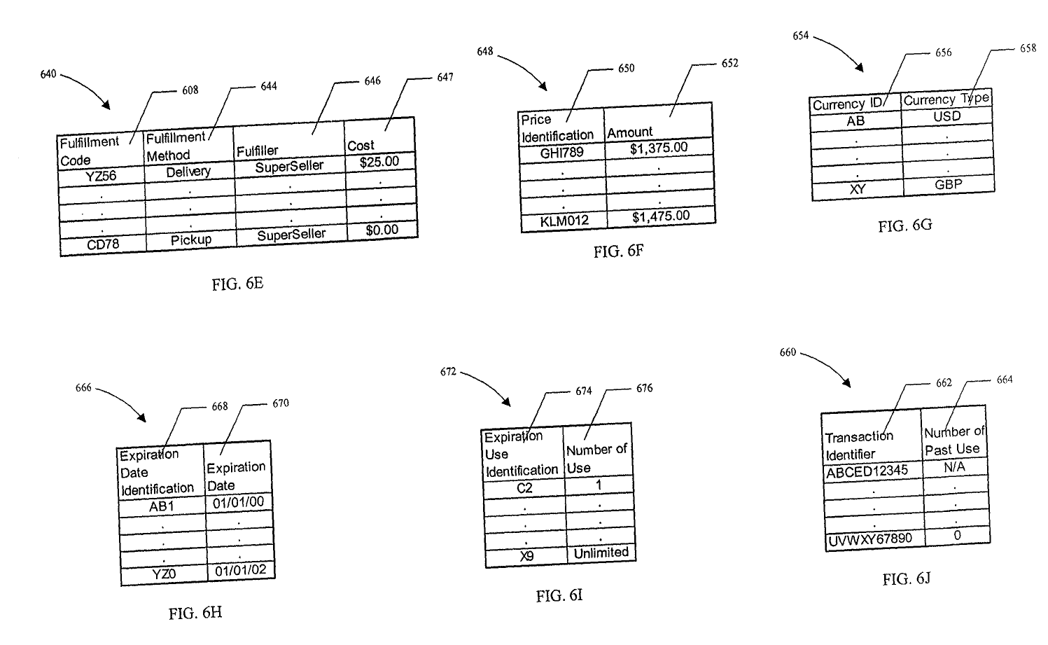

Each string 502 of transaction identifier 112A corresponds to a row in a table 602 (FIG. 6A) of database 126. Each row in table 602 corresponds to a sales transaction between seller 104J and buyer 102I e.g., a unique combination of buyer code in column 604 (that identifies buyer name, address, buyer password, credit card number), product code in column 607 (that identifies manufacturer, seller, and price), and fulfillment code in column 608 (that identifies method of fulfillment, fulfiller, and cost of fulfillment) identified by a transaction identifier in column 603. Note that in this embodiment additional information related to the transaction identifier is also stored in table 602, such as an expiration date in column 611 that identifies the date by when the transaction identifier expires, a limit on the number of past transactions in column 612, which identifies the number of times the buyer can use the same transaction identifier, and actual number of times a buyer has used the transaction identifier in a column 613. Thus, unlike U.S. Pat. No. 5,960,411, transaction identifier 112A corresponds to more than just the identity of the buyer.

Product codes in column 607 can be, for example, the Universal Product Code (UPC) used to identify products from a variety of manufacturers. Of course, product codes in column 607 can be codes from any existing or future code system. Also, such codes may identify services instead of products. Moreover, depending on the embodiment, the code system can be proprietary to an aggregator. Fulfillment code 608 identifies the method by which each transaction is to be fulfilled. Fulfillment methods include delivery of the product to the buyer address identified by the buyer code in column 604 and pickup of the product by the buyer at the seller's location (or another predetermined location). Although some of the columns of table 602 are shown to include values, these columns can alternative contain pointers to values stored in database 126.

In one implementation, when server 116 generates a row in table 602, server 116 sequentially generates string 502 using a predetermined method (e.g. simply counting up from zero through z, and rolling over to the next digit to repeat the counting up). Server 116 then calculates parity checksum 503 for string 502 to form transaction identifier 112A. Server 116 then assigns transaction identifier 112A to the row (i.e., a unique transaction) in table 602. Server 116 never reuses transaction identifier 112A for another unique transaction (i.e. for another row in table 602).

Server 116 generates a row in table 602 under at least two circumstances. First, when a buyer 102I registers (e.g. see act 202 in FIG. 2), server 116 generates a row for this buyer 102I for each product in a product table (that identifies all products that can be offered to buyer 102I). Therefore, if there are a total of P products, server 116 generates P rows for buyer 102I that is being registered. Second, when a seller introduces a new product, server 116 generates a row for each of the M buyers. At any given time, table 602 has a total of M×P rows (and therefore M×P transactions identifiers). The just-described number of rows is doubled if thee are two fulfillment methods, for example. Note that if a product code other than a UPC code is used, a fulfillment method can be included in the product code (i.e., a given product has one product code for one fulfillment method and the same product has another product code for another fulfillment method), and in such a case a transaction identifier can be formed by combining just the product code and the buyer code.

Each string 512 of transaction identifier 112A corresponds to a row in a table 1402 (FIG. 14) of database 126. Table 1402 includes a column 1404 of date stamp codes and a column 1406 of creation dates of transaction identifiers. Transaction identifier 112A can be created on or after the date that string 512 was created.

Transaction identifier 112B (FIG. 5B) is the same as transaction identifier 112A except it further includes an optional issuer code 504 that is uniquely assigned to each issuer of the transaction identifiers (e.g., seller 104J). Issuer code 504 is used to prevent overlap of transaction identifiers when more than one seller utilize the transaction identifiers. If each seller includes its unique issuer code 504 in the same field, e.g., prepends to the above-described transaction identifiers that it creates internally, no two sellers can send the same transaction identifier to buyers.

In one implementation, sellers register with an administrative entity that sequentially assigns issuer identifications to the sellers. For example, an Internet domain name can be used as the issuer identifications. In one variation, issuer identification includes four (4) alphanumeric characters that correspond to a row in a table 620 (FIG. 6B) of database 126. Table 620 includes a column 621 of issuer codes and a column 622 of issuer (e.g., seller) names. Accordingly, in one example, transaction identifier 112B includes a total of eighteen (18) alphanumeric characters where parity checksum 503 (of the type described above) is used to check for errors in the transmission of the other seventeen (17) alphanumeric characters.

In one embodiment, a transaction identifier 112C (FIG. 5C) includes the following strings: buyer code 505, product code 506, and fulfillment code 507. Thus, unlike U.S. Pat. No. 5,960,411, transaction identifier 112A corresponds to more than just the identity of the buyer. In some implementations, transaction identifier 112C (FIG. 5D) further includes the following optional strings: issuer code 504, a price identification 508, a currency identification 509, an expiration date identification 510, an expiration use identification 511, date stamp code 512, and parity checksum 503. In some variations, the alphanumeric characters of the strings are interleaved in a predetermined order as a form of scrambling or encryption. In other implementations, commercial encryption algorithm are used to encode the transaction identifier.

In one implementation, buyer code 505 includes six (6) alphanumeric characters that correspond to a row in a table 623 (FIG. 6C) of database 126. In another implementation, buyer code 505 is the buyer's social security number or a scrambled form of the social security number wherein a predetermined method and/or a predetermined key is used for scrambling. Note that if an expiration date is included in a transaction identifier, a different predetermined key may be used after the expiration date, so that a number of such keys are used in successive time periods.

Server 116 creates a row in table 623 for each buyer from his or her registration information 106. Table 623 includes a column 604 of buyer codes, a column 626 of buyer names, a column 628 of buyer addresses, a column 630 of buyer passwords, and a column 632 of credit card numbers of the buyers. Server 116 sequentially assigns buyer code 505 in column 604 to each unique combination of buyer names, buyer addresses, buyer password, and credit card number.

In one implementation, product code 506 includes eight (8) alphanumeric characters that correspond to a row in a table 634 (FIG. 6D) of database 126. Each row in table 634 corresponds to a product available from seller 104J. Table 634 includes a column 607 of product codes, a column 638 of product numbers, a column 678 of product names, a column 680 of product descriptions, a column 682 of price identifications (each identifies a price of the product), and a column 684 of currency identifications (each identifies a currency type of the price). Server 116 generates product codes by, for example, representing the product numbers in base 36 (alphanumeric characters). Product numbers are, for example, the UPC codes of the products.

In one implementation, fulfillment code 507 includes four (4) alphanumeric characters that correspond to a row in a table 640 (FIG. 6E) of database 126. Each row in table 640 corresponds to an available fulfillment method. Table 640 includes a column 608 of fulfillment codes, a column 644 of fulfillment methods, a column 646 of fulfillers, and a column 647 of fulfillment costs. Server 116 sequentially assigns fulfillment code 507 in column 608 to each unique combination of fulfillment method and fulfiller. Column 644 defines the fulfillment methods, which include delivery to a predetermined location (e.g., buyer's address) and pickup at a predetermined location (e.g., seller's location). In one variation, column 646 defines an entity that will deliver the product to buyer 102I if the fulfillment method is delivery. Alternatively, column 646 defines an entity that serves as the pickup point (e.g., seller 104J) if the fulfillment method is pickup.

In one implementation, price identification 508 includes six (6) alphanumeric characters that correspond to a row in a table 648 (FIG. 6F) of database 126. Server 116 creates various rows in table 648 that define a range of prices for the product. Table 648 includes a column 650 of price identifications and a column 652 of prices. In one variation, server 116 generates a price identification by converting the lowest denomination (e.g., cents in the US and pennies in the UK) into base 36 (alphanumeric character).

In one implementation, currency identification 509 includes two (2) alphanumeric characters that correspond to a row in a table 654 (FIG. 6G) of database 126. Each row in table 654 corresponds to a currency type for the price of the product. Table 654 includes a column 656 of currency identifications and a column 658 of currency types. In one variation, server 116 generates currency identifications by sequentially numbering all the standard three letter currency codes (e.g., USD and GBP) and representing those numbers in base 36.

In one implementation, expiration date identification 510 includes three (3) alphanumeric characters that correspond to a row in a table 666 (FIG. 6H) of database 126. Each expiration date identification 510 corresponds to an expiration date of the transaction identifier 112C. Table 666 includes a column 668 of expiration date identifications and a column 670 of expiration dates. In one variation, server 116 generates expiration date identifications by converting the month, date, and year into base 36. Alternatively, the expiration date is expressed in base 10.

In one implementation, expiration use identification 511 includes two (2) alphanumeric characters that correspond to a row in a table 672 (FIG. 6I) of database 126. Each expiration use identification 511 corresponds to a number of allowed uses of a transaction identifier 112C. Table 672 includes a column 674 of expiration use identifications and a column 676 of numbers of maximum repeat uses of the transaction identifiers. In one variation, server 116 generates expiration use identifications by converting the number of maximum repeat uses into base 36. In the aforementioned implementation, database 126 further includes a table 660 (FIG. 6J) that records the number of past uses of each transaction identifier 112C. Table 660 includes a column 662 of transaction identifiers and a column 664 of the numbers of past uses for each transaction identifier.

Accordingly, in one implementation, transaction identifier 112C includes forty (40) alphanumeric characters where one (1) alphanumeric character of parity checksum 503 is used to check for errors in the transmission of the other thirty-nine (39) alphanumeric characters. In one variation, server 116 further encrypts transaction identifier 112C using a conventional encryption algorithm including data encryption standard (DES) and pretty good privacy (PGP) to add a level of security.

The above methods for generating transaction identifier 112A, 112B, and 112C are exemplary. One skilled in the art understands that other methods and algorithms can be used as well. Furthermore, the order of the strings comprising transaction identifier 112A, 112B, and 112C are not critical.

In action 208 (FIG. 2), seller 104J sends advertisement 110 to buyer 102I. In some implementations, advertisement 110 is a paper advertisement 702 (FIG. 7A) of the type found in printed publications such as pamphlets, catalogs (e.g., catalog 130 in FIG. 1C), and flyers. Seller 104J sends paper advertisement 702 to the address of buyer 102I through mail 122. In one variation, paper advertisement 702 includes a transaction identifier 704 for a sale of a product 114A from seller 104J to buyer 102I that specifies a fulfillment method of delivery, and a transaction identifier 708 for the sale of product 114A from seller 104J to buyer 102I that specifies a fulfillment method of customer pickup. Paper advertisement 702 also includes a transaction identifier 710 for a sale of a product 114B from seller 104J to buyer 102I that specifies a fulfillment method of delivery, and a transaction identifier 714 for the sale of product 114B from seller 104J to buyer 102I that specifies a fulfillment method of customer pickup. Paper advertisement 702 of this example further includes a telephone number 716 where buyer 102I can send a transaction identifier by touch-tone or voice to customer service representative 120, a postal address 718 where buyer 102I can send in a transaction identifier to customer service representative 120, and an Internet address 720 that buyer 102I can access to submit a transaction identifier via web pages (described later). In one implementation, transaction identifiers are provided on stickers (e.g., sticker 134 in FIG. 1E) in paper advertisement 702. If buyer 102I wishes to purchase a product, buyer 102I removes the corresponding sticker, places the sticker on a post card or letter (e.g., post card 132 in FIG. 1E), and mails the post card or letter to seller 104J.

In other implementations, advertisement 110 is a web page that server 116 specifically generates for buyer 102I when buyer 102I access server 116 over network 118. Server 116 can determine the identity of buyer 102I through the cookie stored on buyer 102I's computer. Alternatively, server 116 requests buyer 102I to identify him or herself prior to generating advertisement 110. Subsequently, server 116 stores a cookie on computer 103 that buyer 102I is using to access server 116 so buyer 102I can be automatically identified the next time he or she accesses server 116.

In one variation, advertisement 110 is a web page 722 (FIG. 7B) that includes a hypertext link 724 and a check box 725 for sending transaction identifier 704 to server 116, a hypertext link 726 and a check box 727 for sending transaction identifier 708 to server 116, a hypertext link 728 and a check box 729 for sending transaction identifier 710 to server 116, and a hypertext link 730 and a check box 731 for sending transaction identifier 714 to server 116. If buyer 102I wishes to purchase a single item, buyer 102I can select one of the above described hypertext links to send the corresponding transaction identifier to server 116. Buyer can also select one of the aforementioned check boxes and then a submit button 732 to send the corresponding transaction identifier to server 116. If buyer 102I wishes to purchase multiple items or purchase a single items with two or more fulfillment methods, buyer 102I can select the corresponding check boxes described above and then select submit button 732 to send the corresponding transaction identifiers to server 116. Unlike U.S. Pat. No. 5,960,411, which allows a buyer to purchase a single product by sending one identifier of the buyer to a seller, the present method allows buyer 102I to purchase multiple products by sending multiple transaction identifiers to seller 104J from one web page.

In another variation, advertisement 110 is a web page 734 (FIG. 7C) that includes a button 735 for sending a transaction identifier to server 116 to order product 114A. In another variation, advertisement 110 is a web page 736 (FIG. 7D) that includes button 735, a button 738 for sending a transaction identifier to server 116 to order product 14B, and a button 740 for sending a transaction identifier to server 116 to order product 114C. In another variation, advertisement 110 is a web page 742 (FIG. 7E) that includes check boxes 744, 746, and 748 for respectively selecting transaction identifiers for ordering products 114A, 114B, and 114C, and a button 750 for sending the selected transaction identifiers to server 116 to order the corresponding products. If buyer 102I wishes to purchase multiple items, buyer 102I selects the corresponding check boxes described above and then submit button 750 to send the corresponding transaction identifiers to server 116.

In another implementation, advertisement 110 is an advertisement received through radio 127 (FIG. 1B) or television 128. In this implementation, transaction identifiers in advertisement 110 are not targeted to a specific buyer because advertisement 110 is broadcasted to the general public. In other words, transaction identifiers in advertisement 110 do not identify buyer information in (a) table 602 for transaction identifier 112A or 112B or (b) table 623 for transaction identifier 112C. However, transaction identifiers in advertisement 110 still identify other information in database 126 including product number, fulfillment method, price information, and expiration information. Furthermore, advertisement 110 can include an identification of the region where advertisement 110 is broadcasted. In this implementation, buyer 102I sends his or her address (if buyer 102I desires delivery of product 114) and billing information along with a transaction identifier to seller 104J to purchase a product from seller 104J.

In another implementation, advertisement 110 includes any of transaction identifiers 112A to 112C (collectively referred to as transaction identifier 112) and a list of fulfillment codes 514 of the various fulfillment methods available to buyer 102I. Fulfillment codes 514 are the same as the previously described fulfillment code 507 in transaction identifier 112C. In this implementation, the fulfillment method identified by transaction identifiers 112 is a default fulfillment method selected by seller 104J. To purchase a product with another fulfillment method, buyer 102I sends to seller 104J transaction identifier 112 appended with a fulfillment code 514 (FIG. 13) that identifies his or her preferred fulfillment method. Buyer 102I can send transaction identifier 112 to seller 104J via the telephone, the mail, or the Internet (e.g., using web forms or selecting a transaction identifier and a fulfillment method via check boxes and drop-down lists).

In action 210 (FIG. 2), buyer 102I sends a transaction identifier (e.g., transaction identifier 704 or 708) to seller 104J if buyer 102I wishes to purchase product 114. In the implementation where advertisement 110 is web page 722, buyer 102I sends one or more transaction identifiers to seller 104J via the aforementioned hypertext links, check boxes, web forms, and drop-down lists. In other implementations, buyer 102I can send one or more transaction identifiers to customer service representative 120 by mail 122 or telephone 124 (using voice or touch-tone). As previously described, buyer 102I needs to send additional information in addition to the transaction identifier (e.g., shipping and billing information) to seller 104J if advertisement 110 is a television or radio advertisement.

In one implementation, seller 104J allows buyer 102I to change the fulfillment information during the purchase of product 114 (e.g., prior or subsequent to sending transaction identifier to seller 104J). Thus, buyer 102I can have product 114 delivered to his or her current location if buyer 102I is away from the address listed in database 126. In another implementation, seller 104J regenerates advertisement 110 with new transaction identifiers that identify the new fulfillment information. Buyer 102I purchases product 114 by sending the new transaction identifiers in advertisement 110 to seller 104J.

In action 212, seller 104J optionally verifies the identity of buyer 102I by validating password 108. Server 116 or customer service representative 120 can validate the password by cross-referencing the transaction identifier and the password stored in database 126. In action 214, seller 104J fulfills the order according to the fulfillment information stored in database 126 that correspond to the received transaction identifier (e.g., column 608 in FIG. 6A for transaction identifier 112A or 112B, and columns 644 and 646 in FIG. 6E for transaction identifier 112C). In action 216, seller 104J receives a payment 113 for the order by debiting the credit card account of buyer 102I.

As illustrated in FIGS. 1A and 1B, method 200 can be applied between seller 104J and multiple buyers (e.g., buyers 102A, 102I, and 102M, where A<I<M and M is the total number of buyers).

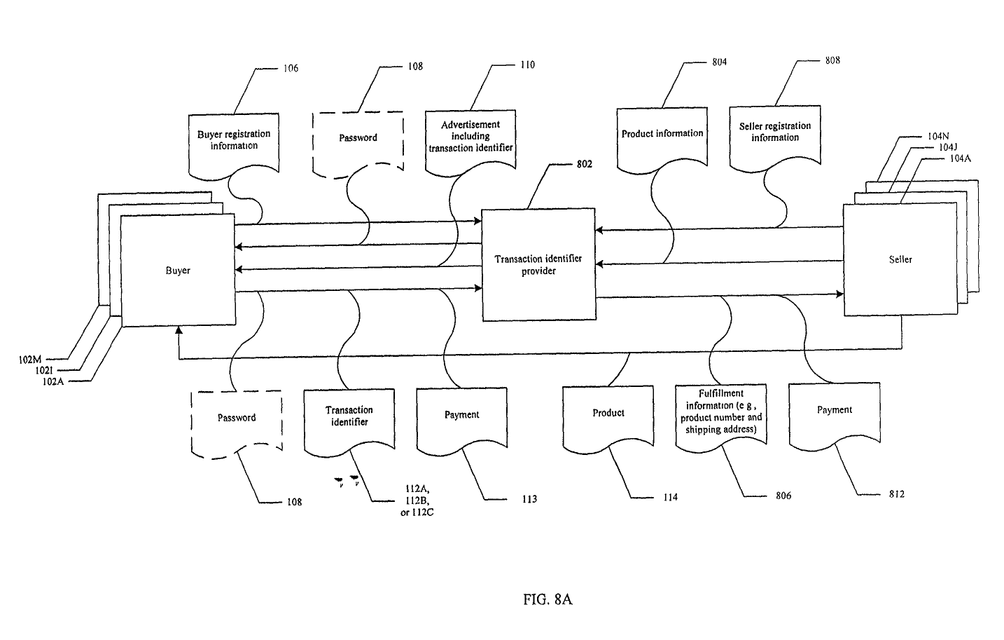

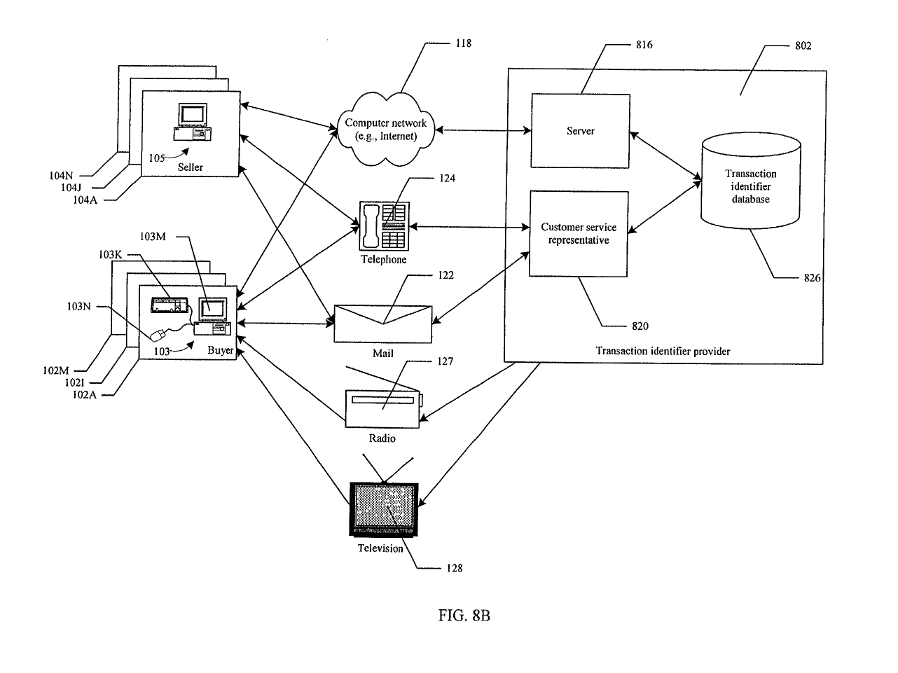

In accordance with a second aspect of the invention, a transaction identifier provider 802 (FIG. 8A) generates transaction identifiers (e.g., transaction identifiers 112A, 112B, or 112C) for transactions between buyer 102I and seller 104J. Provider 802 (also known as an “aggregator”) sends the transaction identifiers in the previously described advertisement 110 to buyer 102I. Buyer 102I sends a transaction identifier for a product he or she wishes to purchase to provider 802. Provider 802 sends fulfillment information 806 (e.g., product number and shipping address) to seller 104J and seller 104J fulfills the order.

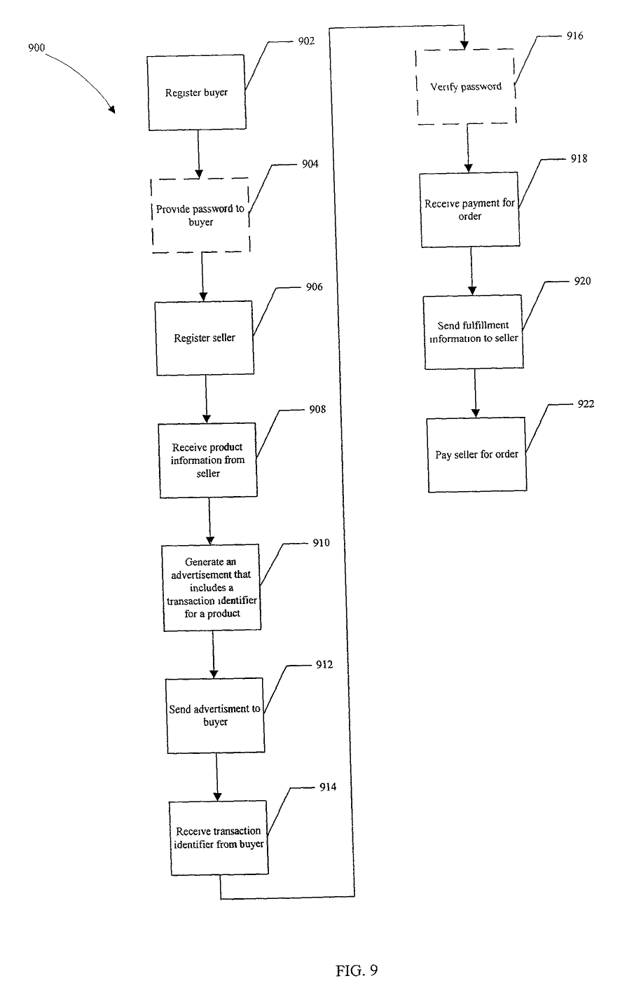

In one embodiment, buyer 102I registers (see action 902 in FIG. 9) with provider 802 by sending his or her name, address, and credit card information (collectively shown as “buyer registration information 106” in FIG. 8A) to provider 802. Action 902 is similar to action 202 except that buyer 102I registers with provider 802 instead of seller 104J. Buyer 102I can register with provider 802 through a web page (e.g., web page 302 in FIG. 3) via a server 816 (FIG. 8B) or a customer service representative 820 via mail 122 or telephone 124 (by voice or touch-tone). Server 816 or customer representative 820 saves registration information 106 in a transaction identifier database 826.

In an action 904 (FIG. 9), service provider 802 optionally sends to or receives from buyer 102I password 108 via a web page, an email (e.g., email 402 in FIG. 4), mail 122, or telephone 124. Action 904 is similar to action 204.

In an action 906 (FIG. 9), seller 104J registers with provider 802 by sending its name, address, telephone number, tax payer identification, and payment information (collectively known as “seller registration information 808” in FIG. 8A). Payment information includes bank account number, wire transfer number, and other similar information that can be used to pay or receive payment from seller 104J. As one skilled in the art understands, seller 104J can send additional seller registration information 808 to establish a business relationship with provider 802.

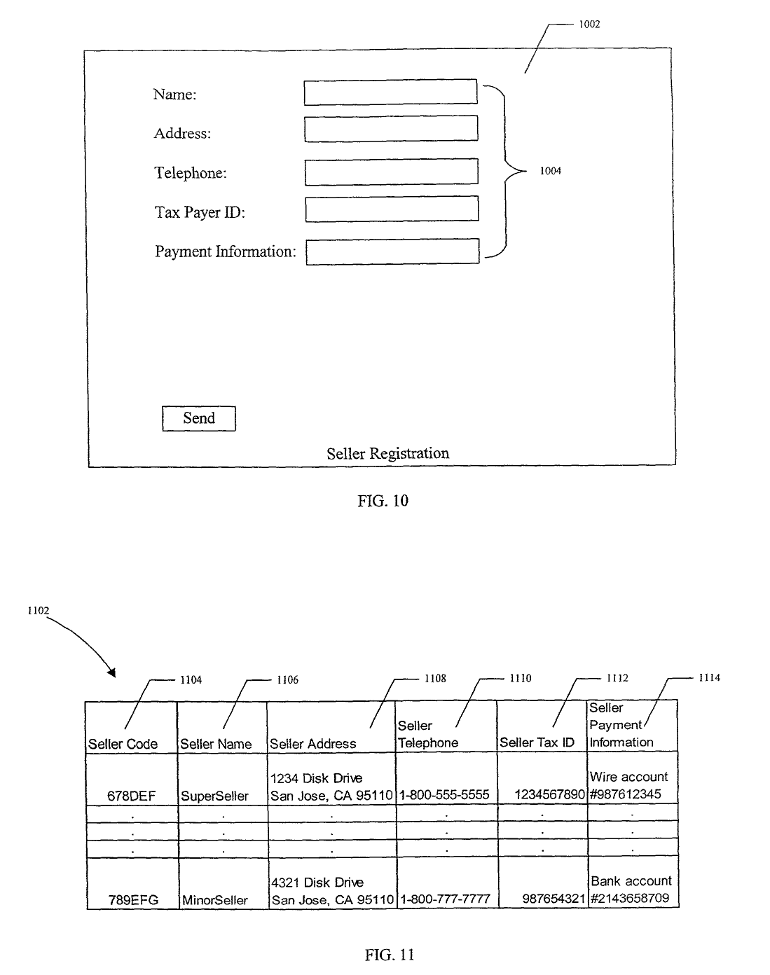

In one implementation, seller 104J registers with provider 108 through a web page 1002 (FIG. 10) generated by server 816. Seller 104J uses a computer 105 (FIG. 8B) to access web page 1002 via computer network 118. Seller 104J fills out fields 1004 to send seller registration information 808 to provider 802. In another implementation, seller 104J registers with provider 802 through customer representative 820 (FIG. 8B) via mail 122 or telephone 124. In one variation, provider 802 and seller 104J communicate with each other via an electronic data interchange (EDI) over network 118 after seller 104J registers with provider 108.

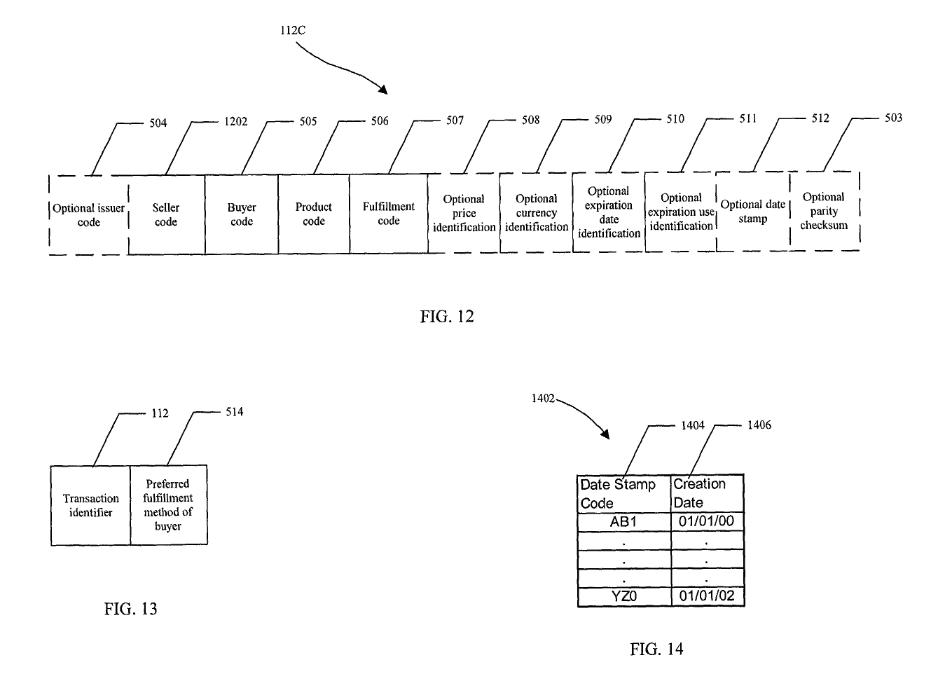

Server 816 or customer representative 820 saves seller registration information 808 in a table 1102 (FIG. 11) in transaction identifier database 826. Table 1102 includes a column 1104 of seller codes, a column 1106 of seller names, a column 1108 of seller addresses, a column 1110 of seller telephones, a column 1112 of seller tax IDs, and a column 1114 of seller payment information. Server 816 creates a row in table 1102 for each seller from its registration information 808. Server 816 sequentially assigns a seller code in column 1104 to each seller. In the implementation using transaction identifier 112C, server 816 adds seller code 1202 (FIG. 12) as an additional string to transaction identifier 112C.

In action 908 (FIG. 9), seller 104J sends product information 804 of a product (e.g., product 114 in FIG. 8A) to provider 802. In one implementation, seller 104J sends product information 804 to provider 802 via EDI. In another implementation, seller 104J sends product information 804 to provider 802 via a document of a predetermined format described in related U.S. patent application Ser. No. ______, entitled “DATA STRUCTURE FOR HOLDING PRODUCT INFORMATION”, inventors Tam et al., filed ______, attorney docket number M-9128 US, which is incorporated by reference in its entirety. Product information 804 includes a product number, a fulfillment method for the product, a price of the product, a limit on the use of a transaction identifier of the product, an expiration use for a transaction identifier of the product, a description of the product, an illustration of the product, and other marketing information. Server 816 saves product information 804 in database 826.

In the implementation using transaction identifier 112A or 112B, server 816 uses product information 804 to create a new row in table 602 to represent a new transaction between buyer 102I and seller 104J. In one variation, server 816 adds columns to table 602 to store pointers to product description, illustrations, and additional marketing information. In another variation, server 816 adds a column to table 602 to store the seller code. Server 816 can cross-reference the seller code to seller registration information 808 stored in table 1102 when server 816 needs to pay seller 104J for a purchase of product 114 (described later).

In the implementation using transaction identifier 112C, server 816 saves new information (information without a corresponding buyer code, product code, fulfillment code, price identification, currency identification, expiration date identification, and expiration use identification) in tables 634, 640, 648, 654, 666, and 672. In one variation, server 816 adds columns to table 634 to store pointers to product description, illustrations, and additional marketing information for product 114. As previously described with server 216, server 816 generates the transaction identifier, buyer code, product code, fulfillment code, price identification, currency identification, expiration date identification, and expiration use identification for the tables in database 826 depending on the implementation of transaction identifier (transaction identifier 112A, 112B, or 112C).

In action 910 (FIG. 9), provider 802 generates advertisement 110 (FIG. 8A) specifically for buyer 102I that includes one or more transaction identifiers for product 114. In one implementation, server 816 generates advertisement 110 by combining one or more transaction identifiers with product information 804 received from seller 104J. In action 912, provider 802 sends advertisement 110 to buyer 102I. As previously described with respect to seller 104J in action 208, provider 802 can send advertisement 110 to buyer 102I over computer network 118 or through mail 122. Also as previously described with respect to seller 104J in action 208, provider 802 can also send advertisement 110 that is not buyer specific over radio 127 or television 128.

In action 914 (FIG. 9), provider 802 receives a transaction identifier from buyer 102I. As previously described with respect to seller 104J in action 210, provider 802 receives the transaction identifier over computer network 118, telephone 124, or mail 122. In action 916, provider 802 optionally verifies password 108 of buyer 102I. As previously described with respect to seller 104J in action 212, server 816 or customer service representative 820 verifies the password by cross-referencing the transaction identifier and the password stored in database 826.

In action 918, provider 802 receives a payment 113 for the purchase of product 114 by debiting the credit card account of buyer 102I. In action 920, provider 802 sends fulfillment information 806 associated to the received transaction identifier to seller 104J via, for example, EDI. In one implementation, server 816 determines fulfillment information 806 by querying database 826 using the received transaction identifier. Fulfillment information 806 includes the product number and the fulfillment method chosen by buyer 102I. Fulfillment method includes delivery and pickup of product 114. If the fulfillment method is delivery of product 114, fulfillment information 806 includes the shipping address of buyer 102I. Seller 104J fulfills product 114 according to the fulfillment method indicated in fulfillment information 806.

In action 922, provider 802 sends a payment 812 to seller 104J for the purchase of product 114 by the payment method specified by seller 104J in seller registration information 808. In one implementation, provider 802 waits for a confirmation that seller 104J has shipped product 114 or that buyer 102I has received product 114 before paying seller 104J. In one variation, payment 812 is the difference between payment 113 received from buyer 102I and a fee for generating and distributing advertisement 110 to buyer 102I.

As illustrated in FIGS. 8A and 8B, method 900 can be applied between provider 802 and multiple sellers (e.g., sellers 104A, 104J, and 104N, where A<J<N and N is the total number of sellers) and buyers (e.g., buyers 102A, 102I, and 102M).

Although the invention has been described with reference to particular embodiments, the description is only of examples and should not be taken as a limitation. For example, the transaction identifier can be used in a system described in related U.S. patent application Ser. No. ______, entitled “E-COMMERCE USING A DATABASE,” inventors Tam et al., filed ______, attorney docket number M-8689 US, which is incorporated by reference in its entirety. Various other adaptations and combinations of features of the embodiments disclosed are within the following claims.

We claim:

1. A signal embodied in a carrier wave identifying a transaction between a buyer and a seller, the signal comprising:
a first string of characters that identifies the buyer in a database;
a second string of characters that identifies a product in the database; and
a third string of characters that identifies a fulfillment method in the database.

2. The signal of claim 1, wherein the first string is sequentially assigned to each buyer.

3. The signal of claim 1, wherein the second string is generated by representing a universal product code (UPC) of the product in a higher base.

4. The signal of claim 1, wherein the third string is sequentially assigned to each fulfillment method.

5. The signal of claim 4, wherein the fulfillment method includes one of delivery of the item to the buyer and pickup of the item by the buyer at a predetermined location.

6. The signal of claim 1, further comprising a fourth string of characters that identifies a price of the product in the database.

7. The signal of claim 6, wherein the fourth string is generated by converting the price to a higher base.

8. The signal of claim 7, further comprising a fifth string of characters that identifies a currency type of the price in the database.

9. The signal of claim 1, further comprising a fourth string of characters that identifies an expiration date to complete the transaction between the buyer and the seller.

10. The signal of claim 9, wherein the fourth string is generated by converting the expiration date to a higher base.

11. The signal of claim 1, further comprising a fourth string of characters that identifies a maximum number of uses of the signal in the database.

12. The signal of claim 11, wherein the fourth string is generated by converting the maximum number of uses to a higher base.

13. The signal of claim 1, further comprising a fourth string of a parity checksum.

14. The signal of claim 1, further comprising a fourth string that identifies an issuer of the signal.

15. The signal of claim 14, wherein the fourth string is sequentially assigned to each issuer of the signal.

16. The signal of claim 15, wherein the issuer of the signal is distinct from the seller.

17. The signal of claim 1, further comprising a fourth string that identifies a date the signal was created.

18. A signal embodied in a carrier wave identifying a unique transaction between a buyer and a seller, the signal comprising a plurality of characters including:
a first string of characters that identifies the buyer in a database;
a second string of characters that identifies a product; and
a third string of characters that identifies at least one of a price for a product, an issuer of one of the first and second strings, an expiration date to complete the unique transaction, a creation date when the signal was created, and a maximum number of times the signal can be used.

19. The signal of claim 18 wherein:
each string identifies a record in a database.

20. A signal embodied in a carrier wave, the signal comprising:
a contiguous set of characters that uniquely identify a transaction for sale of an item by a seller to a buyer.

21. The signal of claim 20 wherein:
said characters are selected from a group consisting of alphanumeric characters and punctuation characters.

22. The signal of claim 20 wherein:
said contiguous set of characters identifies in a database each of the buyer and the item; and
said contiguous set of characters further identifies at least one of: a price for the item, a maximum number of items available at the price, an expiration date to complete the transaction, and a creation date when the signal was created.

23. A method for selling a product, comprising:
generating a string of characters identifying a transaction between a seller and a buyer on a sale of the product before the buyer is aware of the transaction;
sending to the buyer the string of characters;
receiving the string of characters back from the buyer if the buyer wishes to purchase the product; and
using the string of characters to determine at least the product and the buyer.

24. The method of claim 23, further comprising delivering the product to an address of the buyer.

25. The method of claim 23, further comprising associating the string of characters to the buyer, the product, a fulfillment method of the product, and a price of the product.

26. The method of claim 23, wherein said generating comprises sequentially assigning characters to form the string of characters.

27. The method of claim 23, wherein said generating includes assigning a string of characters to an issuer of the string of characters.

28. The method of claim 23, wherein said generating includes assigning a string of characters to a buyer.

29. The method of claim 23, wherein said generating includes assigning a string of characters to a product.

30. The method of claim 23, wherein said generating includes assigning a string of characters to a fulfillment method.

31. The method of claim 23, wherein said generating includes assigning a string of characters to a price.

32. The method of claim 23, wherein said generating includes assigning a string of characters to a currency type.

33. The method of claim 23, wherein said generating includes assigning a string of characters to an expiration date.

34. The method of claim 23, wherein said generating includes assigning a string of characters to a number of maximum uses of the string of characters.

35. The method of claim 23, wherein said generating includes assigning a string of characters to a date the string of characters is created.

36. The method of claim 23, further comprising registering the buyer.

37. The method of claim 36, wherein said registering comprises receiving one or more of a buyer name, an address, billing information, and areas of interest in products.

38. The method of claim 23, wherein said sending comprises sending an advertisement including the string of characters to the buyer.

39. The method of claim 38, further comprising generating an advertisement for the product that includes the string of characters.

40. The method of claim 23, further comprising billing the buyer for the transaction between the buyer and the seller.

41. The method of claim 23, further comprising registering the seller.

42. The method of claim 41, wherein said registering comprises receiving one or more of a name, an address, a telephone number, a tax payer identification, and a payment information.

43. The method of claim 42, further comprising receiving product information from the seller including one or more of a product number, a description, an illustration, a price, a fulfillment method, an expiration date for the transaction, and a maximum number of uses of the string of characters.

44. The method of claim 43, further comprising generating an advertisement from the product information that includes the string of characters.

45. The method of claim 23, further comprising paying the seller for the transaction between the buyer and the seller.

46. The method of claim 23, further comprising sending to the seller the product number and an address of the buyer.

47. A method for purchasing a product, comprising:
receiving a plurality of character strings identifying a corresponding plurality of transactions between a buyer and a seller;
selecting a first string from the multiple strings;
sending the first string to the seller; and
wherein each string identifies at least a product or service, and further identifies information unrelated to said product or service.

48. The method of claim 47, wherein each of the multiple strings identifies a delivery method of a product

49. The method of claim 47, wherein each of the multiple strings identifies a sale of a product.

50. The method of claim 47, further comprising selecting a second string from the multiple strings.

51. The method of claim 50, further comprising sending the second string to the seller.

52. The method of claim 51, wherein a buyer's selection of the first string and said sending the second string occurs concurrently.

53. A first computer displaying a graphical user interface comprising:
a first plurality of product information;
a first check box, wherein a first computer code for the first check box includes a first string identifying a first transaction between a seller and a buyer;
a second plurality of product information; and
a second check box, wherein a second computer code for the second check box includes a second string identifying a second transaction between the seller and the buyer.

54. The computer of claim 53, further comprising a submit button, wherein a third computer code for the submit button includes instructions to send one or more of the first and second strings to a second computer in response to a selection of one or more of the first and second check boxes.

55. A storage medium encoded with a table comprising:
buyer information including buyer names;
product information including product numbers;
fulfillment information including fulfillment methods; and
strings of characters that identifies unique transactions between a buyer and a seller, wherein each string of characters is assigned to a transaction between the buyer and the seller before the buyer is aware of the transaction.

56. The medium of claim 55, wherein the buyer information further includes buyer addresses.

57. The medium of claim 55, wherein the buyer information further includes buyer password.

58. The medium of claim 55, wherein the product information further includes seller names.

59. The medium of claim 55, wherein the product information further includes prices of the products.

60. The medium of claim 55, wherein the fulfillment information further includes a fulfiller.

61. The medium of claim 55, further comprising expiration dates for the use of the strings of characters.

62. The medium of claim 55, further comprising maximum numbers of uses of the strings of characters.

63. The medium of claim 55, further comprising number of past uses of the strings of characters.

64. The medium of claim 55, further comprising creation dates of the strings of characters.
